(19) United States
(12) Patent Application Publication
(10) Pub. No.: US 2022/0030225 A1
(43) Pub. Date: Jan. 27, 2022

(54) VIDEO DATA BURST CONTROL FOR REMOTE TOWERS

(71) Applicant: SAAB AB, Linköping (SE)

(72) Inventor: Henrik ENGSTRÖM, Mölndal (SE)

(21) Appl. No.: 17/291,511

(22) PCT Filed: Nov. 14, 2018
(86) PCT No.: PCT/SE2018/051170

§ 371 Date: May 5, 2021

(51) Int. Cl. H04N 19/107; H04N 19/159; H04N 19/177; H04N 19/172; H04N 19/114

(52) U.S. Cl. CPC H04N 19/107; H04N 19/159; H04N 19/114; H04N 19/172; H04N 19/177

(57) ABSTRACT

The present invention relates to a method for managing data output from multiple cameras of a remote tower via a common transmission media to a central entity, non-transitory computer-readable storage medium, and a corresponding remote tower system. The method comprises determining a global GOP sequence for the multiple cameras, determining a first distribution of I-frames within the global GOP sequence and forming a second distribution of I-frames within that global GOP sequence by moving the I-frame of at least one camera. The proposed method allows for transmitting data from a remote virtual tower to a control centre with reduced data peaks whereby the data can be transmitted without additional buffering and the end-to-end transmission delays can be kept at low level.

### TECHNICAL FIELD OF THE INVENTION

The present invention relates to data management method for remote towers of a remote Air Traffic Control (ATC) system. More specifically, the present invention relates to a method for managing data output from multiple cameras of a remote tower via a common transmission media to a central entity.

### BACKGROUND

Remote and digital tower is a new concept where the Air Traffic Service (ATS) at an airport is performed somewhere else than in the local control tower. In these systems one uses multiple cameras to monitor the air and ground traffic at an airport. The camera output is transmitted in real-time to a central location where air traffic controllers view the camera video and control the traffic at the airport.

The transmission media from the airport to the central location often has limited capacity, and at the same time very strict requirements in terms of data loss and delay. In general, the data output from each camera varies a lot. If the cameras are allowed to transmit their data without any control, the capacity of the transmission media may easily be exceeded.

Accordingly, there is need for an active bandwidth control function; otherwise, one runs a high risk of frequent data loss, which is unacceptable in ATS environments.

To this end, a conventional solution to this problem is to buffer the data and send it out at a constant pace (i.e. a “leaky-bucket” technique). However, such methods suffer from a general drawback of introducing relatively large end-to-end transmission delays. Alternatively one could contemplate increasing the maximum available bandwidth, this is however generally not applicable from a cost perspective.

There is therefore a need in the art for a new method which allows the data to be transmitted without additional buffering, and which allows the end-to-end transmission delays to stay low in a cost-effective manner.

### SUMMARY OF THE INVENTION

It is therefore an object of the present invention to provide a method for managing data output from multiple cameras of a remote tower via a common transmission media to a central entity, a non-transitory computer-readable storage medium, and a remote tower system, which alleviate all or at least some of the above-discussed drawbacks of presently known systems.

The term exemplary is the present context to be understood as serving as an example, instance or illustration.

This object is achieved by means of a method for managing data output from multiple cameras of a remote tower via a common transmission media to a central entity, wherein each camera is configured to periodically output an I-frame (Intra frame) in a Group of Pictures (GOP) sequence. The method comprises:

determining a global GOP sequence for the multiple cameras, the global GOP sequence comprising the I-frame of each camera of the multiple cameras;

determining a first distribution of I-frames within the global GOP sequence;

forming a second distribution of I-frames within the global GOP sequence by moving the I-frame of at least one of the multiple cameras within the global GOP sequence so that the second distribution is different from the first distribution.

The proposed method allows for transmitting data from a remote tower to a control centre with reduced data peaks. More specifically, the video data can be transmitted without additional buffering while at the same time keeping the end-to-end transmission at low level. Stated differently, the method allows for effectively controlling the data output of the cameras in such a way that they do not form momentary large peaks in the total bandwidth which may cause data loss.

The video output (data output from the cameras) are encoded by a method which generates an image output (data output) comprising an I-frame (Intra frame) in a Group of Pictures (GOP) sequence.

The step of moving an I-frame may for example include shortening a single GOP sequence for a specific camera so that the future I-frames are being generated and transmitted at their designated positions within the global GOP sequence. The shortening can be done by e.g. requesting a new I-frame at a specific point in time within the global GOP sequence, which will consequently move the start of individual GOP sequence to that point in time. However, the step of moving an I-frame may alternatively be done by extending a single GOP sequence for a specific camera so that the future I-frames are being generated and transmitted at their designated positions within the global GOP sequence.

Further, in reference to the encoding, the data output (i.e. the video output) is digitally encoded by a method that uses I-frames together with Predicted Frames (P-frames) and possibly Bi-directional Frames (B-frames). I-frames are larger than the other frames (P-frames/B-frames) and can be said to form peaks in the output bandwidth from the cameras. The I-frames can further be said to contain the full image and do therefore not require any additional information to reconstruct them. Typically, encoders use GOP structures that cause each I-frame to be a “clean random access point,” such that decoding can start cleanly on an I-frame.

In more detail, a GOP may include an I-frame, one or more P-frames, and one or more B-frames. The I-frame (intra coded picture) is a picture that is coded independently of all other pictures. Each GOP begins (in decoding order) with this type of picture. As mentioned, the I-frame is a complete image, like a jpeg image file. The P-frame (predictive coded picture) holds only the changes in the image from the previous frame. For example, in a scene where an object moves across a stationary background, only the object's relative movements are encoded. Accordingly, the encoder does not need to store the unchanging background pixels in the P-frame, thereby saving space. P-frames may also be known as delta-frames. The B-frame (bi-predictive coded picture) saves even more space by using differences between the current frame and both the preceding and following frames to specify its content.

In the present context, the terms “frame” and “picture” are used interchangeably, and even though the term “frame” is mainly used in the present disclosure, it is considered to encompass both a complete image and a partial image (i.e. a field). Moreover, the term remote tower should in the present context be interpreted broadly, and may for example include embodiments where the cameras are spatially distributed at an airport instead of gathered in a tower-like structure.

The present invention is at least partly based on the realization that if the data output from the cameras is left un-controlled there is a relatively high probability that I-frames will be clustered together in time and cause large peaks in the total bandwidth when summed together. In particular, the present inventor realized that the common transmission media is limited such that if the output bandwidth from a plurality of cameras peak closely in time, the system will “drop” video data in such way that it will not be received at the receiving side. In other words, if the bandwidth limit is exceeded, data loss will occur, which is for obvious reasons inacceptable in Air Traffic Control applications.

Thus, by actively controlling the data output from each camera and moving specific individual GOP sequences in order to form a new “ordered” distribution where the I-frames are evenly spread in time, these adverse effects may be mitigated. In more detail, the “ordered” situation will reduce the risk of forming large data peaks in the total bandwidth and thereby increase the chances of sending the data over the common transmission media without data loss.

Further, in accordance with an exemplary embodiment of the present invention, the method further comprises identifying, in the first distribution of I-frames, at least one time slot comprising at least two I-frames, the time slot being of a limited length shorter than the global GOP sequence;

wherein the step of forming the second distribution comprises:
moving at least one I-frame of the at least two I-frames from the at least one time slot to a different time slot within the global GOP sequence.

A time slot may in the present context be understood as a limited subsection or part of the “time-axis” of the global GOP sequence. Accordingly, the I-frames are moved from time slots (in the global GOP sequence) which are considered as running a relatively high risk of momentarily exceeding bandwidth limits, to a different time slot. Preferably, the I-frames are moved to arbitrary time slots which contain no I-frames.

Thus, according to another exemplary embodiment of the present invention, the step of determining a first distribution of I-frames within the global GOP sequence comprises:

dividing the global GOP sequence into a plurality of subsections;

identifying at least one high-density subsection, wherein the high-density subsection comprises a number of I-frames above a first predefined threshold;

identifying at least one low-density subsection, wherein the low-density subsection comprises a number of I-frames below a second predefined threshold;

wherein the step of forming the second distribution within the global GOP sequence comprises:
moving an I-frame from each identified high-density subsection to a corresponding low-density subsection. The first predefined threshold and the second predefined threshold may be 1.0, so that any subsection having two or more I-frames is classified as a high-density subsection and any subsection having zero I-frames is classified as a low-density subsection. The remaining subsections (the subsections containing only one I-frame) may be classified/identified as normal-density subsections. The subsections are preferably of equal length. However, in some exemplary embodiments the first predefined threshold may be 2.0, 3.0 or 4.0, and the second predefined threshold may be 2.0, 3.0 or 4.0. In particular, the first predefined threshold may be 3.0 and the second predefined threshold may be 2.0.

Stated differently, the global GOP sequence is arranged in a plurality of defined subsections or parts. This may for example be done by forming a timeline and recording every time an I-frame occurs in the global GOP sequence. Then this timeline is then divided into a plurality of segments forming the subsections. The subsections are then classified based on how many “recordings” they contain. Subsequently, the I-frames are moved from the subsections that contain a relatively high number of I-frames to subsections that contain a relatively low number (e.g. zero) I-frames in order to even out the spread of I-frames within the global GOP sequence, thereby reducing the risk of momentary peaks in bandwidth in the data output.

Further, in accordance with another exemplary embodiment of the present invention, the global GOP sequence comprises N I-frames, wherein the step of dividing the global GOP sequence into a plurality of subsections comprises:

dividing the global GOP sequence into N subsections; and

wherein the step of forming the second distribution within the global GOP sequence comprises:
moving an I-frame from each identified high-density subsection to a corresponding low-density subsection such that each subsection out of the N subsections comprises one I-frame. In other words, the second distribution is formed such that it contains N subsections and each subsection contains one I-frame.

Still further, in accordance with yet another exemplary embodiment of the present invention, the step of dividing the global GOP sequence into N subsections comprises:

forming a group of subsections comprising a series of the N subsections;

aligning the group of subsections with said global GOP sequence based on a predefined metric. One example of such a predefined metric is to minimize the sum of absolute differences between the time stamp of an I-frame and the closest central point of a section. Another example of such a predefined metric is to minimize the sum of the squared differences between the time stamp of an I-frame and the closest central point of a section. Moreover, the step of forming the second distribution of I-frames within the global GOP sequence may further comprise changing a status of each low-density subsection to a normal-density subsection when the I-frame is moved thereto.

Further, in accordance with another aspect of the present invention, there is provided a non-transitory computer-readable storage medium storing one or more programs configured to be executed by one or more processors of a remote tower system, the one or more programs comprising instructions for performing the method according to any one of the above discussed embodiments in reference to the first aspect of the present invention. Thus, with this aspect of the invention, similar embodiments and advantages are present as in the previously discussed first aspect of the invention.

Yet further, in accordance with another aspect of the present invention, there is provided a remote tower system for air traffic control comprising:

a plurality of cameras arranged to transmit data output via a common transmission media to a central entity, each camera being configured to periodically output an I-frame in a Group of Pictures, GOP, sequence:

a controller arranged to monitor and control the data output of each camera onto the common transmission media, the controller being configured to:

determine a global GOP sequence for the plurality of cameras, the global GOP sequence comprising the I-frame of each camera of the plurality of cameras;

determine a first distribution of I-frames within the global GOP sequence; form a second distribution of I-frames within the global GOP sequence by moving the I-frame of at least one of the plurality of cameras within the global GOP sequence so that the second distribution is different from the first distribution. With this aspect of the invention, similar embodiments and advantages are present as in the previously discussed first aspect of the invention, and vice versa.

The controller (may also be referred to as a control unit) can be provided by means of appropriate software, hardware or a combination thereof. Moreover, the controller may be referred to as a “supervisor unit” which is configured to monitor the data output on the common transmission media directly or indirectly by monitoring the output from each individual camera.

In accordance with an exemplary embodiment of the present invention, the controller is further configured to identify, in the first distribution of I-frames, at least one time slot comprising at least two I-frames, the time slot being of a limited length shorter than the global GOP sequence; and form the second distribution of I-frames within the global GOP sequence by moving at least one I-frame of the at least two I-frames from the at least one time slot to a different time slot within the global GOP sequence. As mentioned, a time slot may in the present context be understood as a defined subsection of the time-axis of the global GOP sequence.

Further, according to yet another exemplary embodiment of the present invention, the controller is further configured to arrange the global GOP sequence into N subsections by forming a group of subsections comprising the N subsections, and aligning the group of subsections with said global GOP sequence based on a predefined metric. The group of subsections may be construed as a series of subsections, each subsection having a defined length in time.

Moreover, in accordance with another exemplary embodiment of the present invention, the controller is further configured to change a status of each low-density subsection to a normal-density subsection when the I-frame is moved thereto. Thus, once all of the subsections are labelled or marked as normal-density subsections the rearranging of the I-frames may be considered to be completed.

These and other features and advantages of the present invention will in the following be further clarified with reference to the embodiments described hereinafter.

### BRIEF DESCRIPTION OF THE DRAWINGS

For exemplifying purposes, the invention will be described in closer detail in the following with reference to embodiments thereof illustrated in the attached drawings, wherein:

FIG. 1 is a schematic perspective view illustration of a remote tower system for air traffic control in accordance with an embodiment of the present invention;

FIG. 2a is a schematic plot illustrating the data output from one camera in a remote tower system in accordance with an embodiment of the present invention;

FIG. 2b is a schematic plot illustrating a first distribution of the data output from a plurality of cameras in a remote tower system in accordance with an embodiment of the present invention;

FIG. 2c is a schematic plot illustrating a second distribution of the data output from a plurality of cameras in a remote tower system in accordance with an embodiment of the present invention;

FIG. 3 is a flow chart representation of a method for managing data output from multiple cameras of a remote tower in accordance with an embodiment of the present invention;

FIG. 4 is a block chart representation of a remote tower system in accordance with an embodiment of the present invention.

### DETAILED DESCRIPTION

In the following detailed description, some embodiments of the present invention will be described. However, it is to be understood that features of the different embodiments are exchangeable between the embodiments and may be combined in different ways, unless anything else is specifically indicated. Even though in the following description, numerous specific details are set forth to provide a more thorough understanding of the present invention, it will be apparent to one skilled in the art that the present invention may be practiced without these specific details. In other instances, well known constructions or functions are not described in detail, so as not to obscure the present invention.

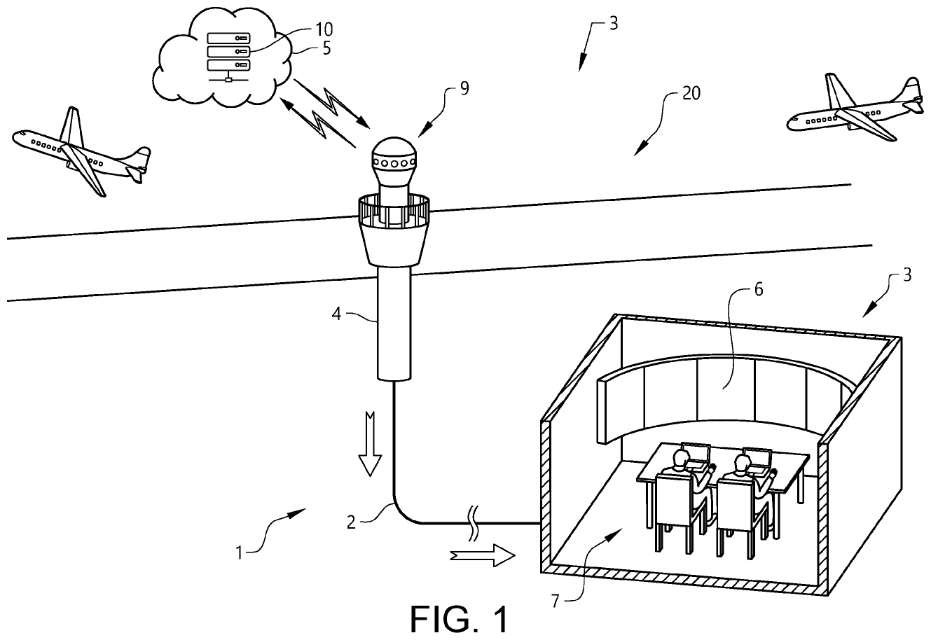

FIG. 1 illustrates a schematic overview of a remote tower system 1 in an Air Traffic Control (ATC) application, according to an exemplary embodiment of the present invention. In more detail, FIG. 1 shows a remote tower 4 arranged at an airport 20. The remote tower 4 may also be referred to as a remote and digital tower and can generally be explained as a solution where the Air Traffic Service (ATS) is performed somewhere else 3 than in a local control tower. In more detail, a general remote tower system has a remote ATC control room 3 with a video-sensor 9 based surveillance instead of the conventional “out-of-the-window” view from a real tower. The optical sensors 9 (e.g. cameras) supply the Air Traffic Control Officer(s) 7 at the remote tower centre 3 with a high-quality real-time image feed of the runway, the movement area, and the nearby airspace. The real-time images are displayed at large monitors 6 providing up to a 360-degree view of the area around the remote tower 4.

The remote tower 4 may for example comprise more than ten cameras (such as e.g. twelve or fourteen cameras) arranged in a camera house. The camera house is arranged to protect the cameras from weather (rain, snow, hail, moisture, etc.), high and low temperatures, sunlight, insects, birds, etc. The cameras 9 may be any type of suitable optical sensors such as e.g. high definition video cameras, infrared cameras, night vision cameras, etc. Moreover, the remote tower may also be realized as a plurality of cameras or groups of cameras spatially distributed at different locations (not shown) overlooking the airport, instead of being gathered in a single tower-like structure as illustrated in the drawing.

As the skilled artisan realizes the remote tower 4 further may further be provided with radar systems, microphones, and any other suitable arrangements used in general ATC applications. These aspects are however considered obvious for the skilled reader and will for the sake of brevity and conciseness not be further discussed in any detail.

Moving on, the plurality of cameras 9 are arranged to transmit a data output (i.e. an image feed or video feed) via a common transmission media 2 (e.g. wide area network) to a central entity 3 (e.g. control centre). The term common with respect to the common transmission media is to be understood as “shared by” and not as “ordinary” or “conventional”. Moreover, the common transmission media may be realised by a wired connection, wireless connection, or a combination thereof. The data output, i.e. the video output is digitally encoded by a method that uses I-frames together with Predicted Frames (P-frames) and possibly Bi-directional Frames (B-frames). Accordingly, each camera 9 is configured to generate an image output (video output) comprising an I-frame (Intra frame) in a Group of Pictures (GOP) sequence.

I-frames are larger than the other frames (P-frames/B-frames) and can be said to form peaks in the output bandwidth from the cameras 9. The I-frames can be said to contain the full image and do therefore not require any additional information to reconstruct them. Typically, encoders use GOP structures that cause each I-frame to be a “clean random access point,” such that decoding can start cleanly on an I-frame.

In these compression standards (video coding designs), the full frame (I-frame) is stored only at specific intervals of e.g. one per second, and encodes the rest of the frames (P-frames and B-frames) only with the differences caused by motion in the video. The time interval for I-frames varies (e.g. multiple times per second, or once every second, once every 10 seconds, etc.). The more I-frames that are to be transmitted, the larger the video stream will be which requires more bandwidth capacity. However, the more I-frames the video stream has, the more editable it is.

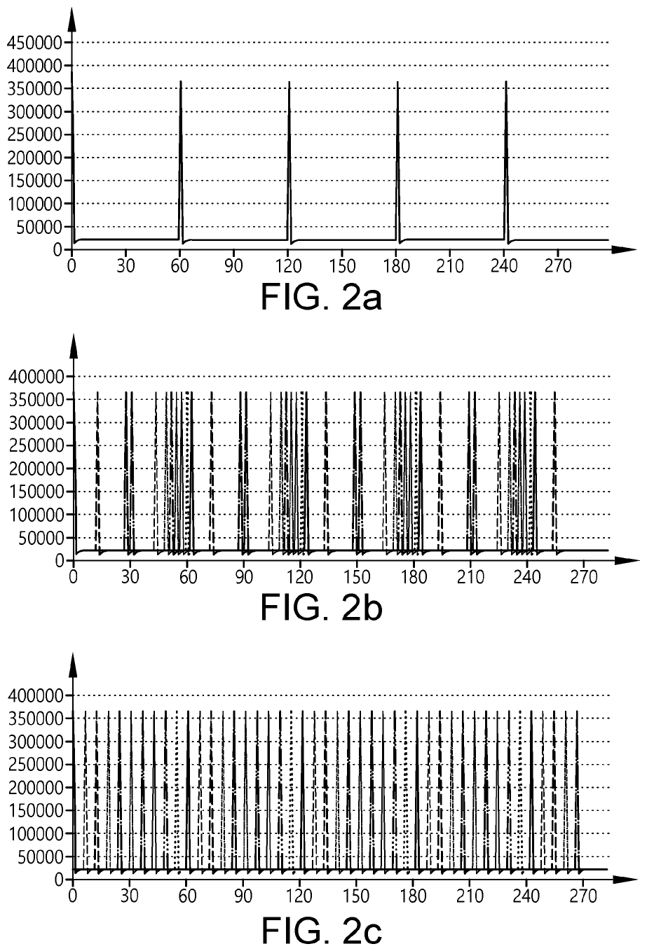

An example of data output from a camera 9 can be seen in FIG. 2a, where the large peaks are I-frames and the P-frames are barely visible between the I-frames. The GOP is 60 frames in the illustrated example in FIG. 2a. The plots in FIGS. 2a-2c are amount of data, e.g. bytes, (y-axis) over output frame index (x-axis).

In more detail, a GOP may include the following picture types:
I-frame (intra/inter coded picture). An I-frame is a picture that is coded independently of all other pictures. Each GOP begins (in decoding order) with this type of picture.
P-frame (predictive coded picture). The P-frame contains motion-compensated difference information relative to previously decoded pictures.
B-frame (bi-predictive coded picture). A B-frame also contains motion-compensated difference information relative to previously decoded pictures.

Further, the remote tower system 1 has a controller 10 (may also be referred to as a control unit), here as a part of a remote server/controller, such as e.g. a cloud-based system 5, arranged to monitor and control the data output of each camera 9 onto the common transmission media 2. More specifically, the controller 10 is arranged to monitor the data output from each camera in real-time, and is capable of moving the GOP sequence for each individual camera by e.g. an external command.

The controller 10 is configured to determine a global GOP sequence for the plurality of cameras 9, where the global GOP sequence comprises the I-frame of each camera of the plurality of cameras 9. Thereafter, the controller 10 analyses the global GOP sequence and determines or observes a first distribution of I-frames within the GOP. An example of this can be seen in FIG. 2b, showing data output from 10 individual cameras 9, where the peaks represent I-frames from each of the cameras. The plot shows four full global GOP sequences. The global GOP sequences in FIG. 2b comprise output from ten individual cameras. It should be noted that this is merely an example of a first (un-ordered distribution) chosen for illustrative purposes. As the skilled reader realizes, the data peaks may be partly or completely overlapping in some areas, which would further elucidate the problems in terms of exceeding bandwidth limits, particularly when considering the aggregated data output over time (not shown).

Further, the controller 10 is configured to form a second distribution of I-frames within the global GOP sequence by moving the I-frame of at least one of the plurality of cameras 9 within the global GOP sequence so that the second distribution is different from the first distribution. For example, the controller 10 may be configured to form a second distribution of I-frames within the global GOP sequence by moving the I-frame of at least one of the plurality of cameras 9 within the global GOP sequence so that the I-frames are more evenly distributed within the global GOP sequence as compared to the first distribution.

The step of moving an I-frame may for example include shortening a single GOP sequence for a specific camera so that the future I-frames are being generated and transmitted at their designated positions within the global GOP sequence. The shortening can be done by e.g. requesting a new I-frame at a specific point in time within the global GOP sequence, which will consequently move the start of individual GOP sequence to that point in time. However, the step of moving an I-frame may alternatively be done by extending a single GOP sequence for a specific camera so that the future I-frames are being generated and transmitted at their designated positions within the global GOP sequence.

An example of a resulting second distribution is illustrated in FIG. 2c, showing the sequence from FIG. 2b but where the I-frames are re-ordered in time (x-axis). As can be understood from the two plots in FIGS. 2b and 2c, the risk of exceeding a bandwidth limit of a transmission media is relatively high in the high-density sections around frame index 60, 120, 180, 240 in the first distribution illustrated in FIG. 2b. However, in the second distribution, the peaks defined by the I-frames are more evenly distributed in time, which reduces the risk of temporary aggregated transmission peaks.

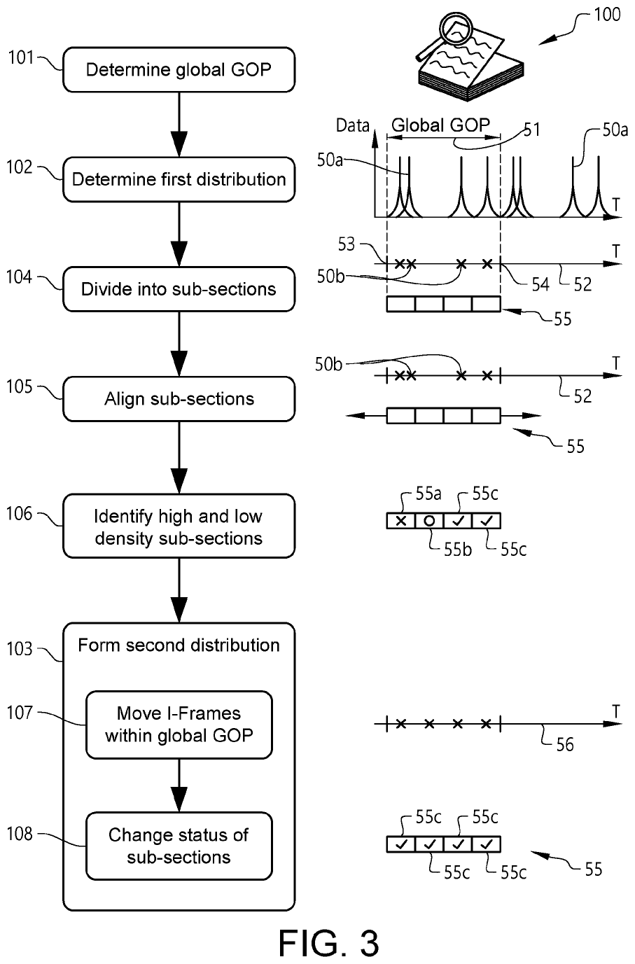

FIG. 3 is a schematic flow chart representation of a method 100 for managing data output from multiple cameras of a remote tower via a common transmission media to a central entity. Each camera is here configured to periodically output an I-frame 50a in a GOP sequence. The method 100 comprises a step of determining 101 a global GOP sequence 51 for the plurality of cameras. The global GOP sequence 51 includes the I-frame 50a of each camera of the multiple cameras.

Further, a first distribution of I-frames 50a within the global GOP sequence 51 is determined 102. This may for example be construed as forming a timeline 52 and recording, on the timeline, when each camera emits an I-frame 50a. Each I-frame 50a is accordingly marked with a representation 50b on the timeline 52. The start 53 of the global GOP sequence 51 and the end of the global GOP sequence 54 accordingly serve as a start and stop of the “recording”. Next, the global GOP sequence 51 is divided 104 into a plurality of subsections 55. Preferably, the global GOP sequence 51 is divided into as many subsections 55 as there are I-frames 50a within the global GOP 51. In the illustrated example, the global GOP sequence 51 comprises the data output from four cameras, and accordingly includes four I-frames 50a resulting in four subsections 55. Alternatively, the method 100 may comprise a step of identifying subsections 55 in the formed global GOP sequence timeline 52.

The subsections 55 are then arranged in a group of subsections 55. The group includes the individual subsections arranged in a sequential manner. The total length (in time) of the group of subsections 55 is equal to the length (in time) of the global GOP sequence 51.

Moving on, high-density subsections 55a and low-density subsections 55b are identified 106. A high-density subsection 55a can be construed as a subsection having a relatively high-density of I-frames, e.g. two or more I-frames 50a. In more detail, a high-density subsection 55a can be understood as a subsection of the global GOP sequence that is more likely to exceed available bandwidth on the common transmission media than other subsections (low and normal-density subsections). A low-density subsection 55b can be construed as subsection having a relatively low-density of I-frames 50a, e.g. zero I-frames. In more detail, a low-density subsection 55b can be understood as a subsection in the global GOP sequence that into which one can insert additional I-frames without exceeding the bandwidth of the common transmission media. The amount of data that has to be transmitted per second from the plurality of cameras is referred to as bandwidth. It is generally measured in bit/s, but may also be measured in byte/s which equals to ⅛^{th} of the corresponding bitrate.

Moreover, the method 100 may further comprise identifying or classifying the remaining subsections as normal subsections 55c. Accordingly, the step of classifying 106 subsections 55 in the group of subsections 55 may for example be such that:
If the subsection contains zero I-frames, that section is classified/identified as a low-density subsection.
If the subsection contains two or more I-frames, that section is classified/identified as a high-density subsection.
If the subsection contains one and only one I-frame, that section is classified/identified as a normal-density subsection.

As an option, the method may include a step of aligning 105 the group of subsections 55 by some predefined metric before identifying/classifying the subsections as high, low and normal-density. More specifically, the alignment 105 or adjustment may be understood optimizing the placement of the group of subsections 55 on the formed timeline 52 representation of the global GOP sequence 51. The predefined metric may for example be to minimize the sum of absolute differences between the time stamp of an I-frame 50a and the closest central point of a subsection 55. In other words, the step of aligning 105 the group of subsections may comprise adjusting the position in time of the group of subsections 55 such that a sum of an absolute difference between a time stamp of an I-frame 50a and a closest central point of a subsection is below a first predefined threshold.

Another example of a predefined metric is to minimize the sum of the squared differences between the time stamp of an I-frame 50a and the closest central point of a section 55. In other words, the step of aligning 105 the group of subsections may comprise adjusting the position in time of the group of subsections 55 such that a sum of a squared difference between a time stamp of an I-frame 50a and a closest central point of a section 55 is below a second predefined threshold.

Further, the method 100 includes a step of forming 103 a second distribution of I-frames 50 within the global GOP sequence 51 by moving 107 the I-frame 50a of one or more cameras within the global GOP sequence 51 such that the second distribution is different from the first distribution. In more detail, one of the I-frames 50a in the high-density subsection 55a is moved to the low-density subsection 55b. More specifically, the I-frame 50a is moved to a different point in time within the interval defined by the low-density subsection 55b. Preferably, the I-frame 50a is moved to a center point of the interval defined by the low-density subsection 55b. Once, all of the relevant Intra frames 50a are moved and the second distribution is formed, as indicated by the time-line 56 showing representations (marked with an x) of the position of each I-frame 50a in the second distribution of I-frames 50a within the global GOP sequence 51. The method may further comprise a step of changing 108 the status of the subsections from a high/low-density subsection to a normal subsection 55c.

Thus, on a general level, the forming 103 of the second distribution may include populating a list {A} with I-frames 50a that are out of order by taking I-frames 50a from high-density subsections 55a until there are no more high-density subsections left. For each selected I-frame 50a the method 100 may also include making a note of where it shall be moved within the global GOP sequence (i.e. to a free low-density subsection 55b).

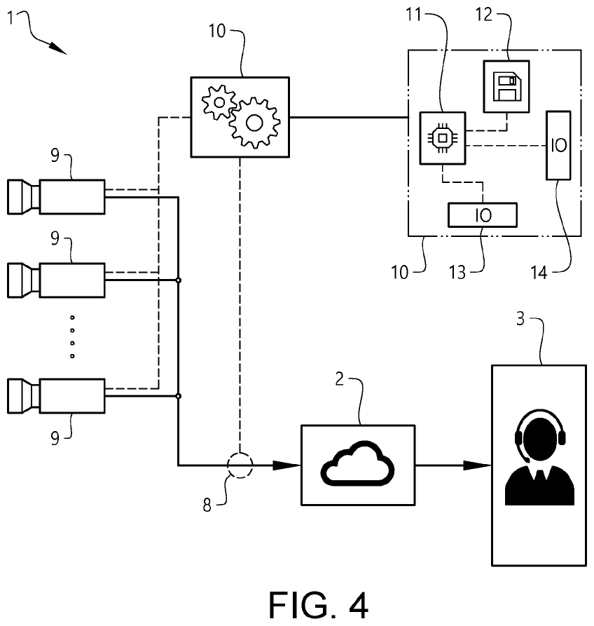

FIG. 4 is a schematic block diagram illustrating a remote tower system 1 according to an exemplary embodiment of the present invention. The remote tower system 1 has a plurality of cameras 9 arranged to transmit data output via a common transmission media 2 to a central entity 3. The data output is generally in the form of images or parts of images of the surrounding environment of the cameras 9. Each camera 9 is configured to periodically output an Intra Frame in a GOP sequence.

The system 1 further has a controller 10 connected to each camera 9. The controller 10 is arranged to monitor 8 and control the data output (in real-time) of each camera 9 onto the common transmission media 2. Even though only three cameras 9 are illustrated in FIG. 4, the skilled reader readily realizes that the system 1 may comprise any suitable number of cameras to provide an adequate overview of the surrounding area around the vantage point formed by the remote tower at the airport.

It should be noted that the controller 10 may for example be manifested as a general-purpose processor, an application specific processor, a circuit containing processing components, a group of distributed processing components, a group of distributed computers configured for processing, a field programmable gate array (FPGA), etc. The controller 10 may for example be in the form of a circuit having a processor 11 such as e.g. a microprocessor, microcontroller, programmable digital signal processor or another programmable device. The controller 10 may also, or instead, include an application-specific integrated circuit (ASIC), a programmable gate array or programmable array logic, a programmable logic device, or a digital signal processor. Where the controller 10 includes a programmable device such as the microprocessor, microcontroller or programmable digital signal processor mentioned above, the processor 11 or an associated memory 12 may further include computer executable code that controls operation of the programmable device.

It should be understood that the controller 10 may comprise a digital signal processor arranged and be configured for digital communication with an off-site server or cloud based server. Analogously, if the controller 10 is part of a cloud based system (as depicted in FIG. 1), the digital signal processor may be configured for digital communication with one or more local control units associated with the cameras 9. Thus, data may be sent to and from the controller 10, as readily understood by the skilled reader.

Further, it should be understood that parts of the described solution may be implemented either in the controller 10, in a system located external the controller 10, or in a combination of internal and external the controller 10; for instance in a server in communication with the controller 10, a so called cloud solution. For instance, communication signal may be sent to an external system and that external system performs the steps to determine how to move the I-frames so to form the second distribution and send back information indicating the moving process and other relevant parameters used in forming the second distribution.

The processor 11 (of the controller 10) may be or include any number of hardware components for conducting data or signal processing or for executing computer code stored in memory 12. Accordingly, controller 10 may have an associated memory 12, and the memory 12 may be one or more devices for storing data and/or computer code for completing or facilitating the various methods described in the present description. The memory 12 may include volatile memory or non-volatile memory. The memory 12 may include database components, object code components, script components, or any other type of information structure for supporting the various activities of the present description. According to an exemplary embodiment, any distributed or local memory device may be utilized with the systems and methods of this description. According to an exemplary embodiment the memory 12 is communicably connected to the processor 11 (e.g., via a circuit or any other wired, wireless, or network connection) and includes computer code for executing one or more processes described herein.

Moreover, depending on functionality provided in the controller 10 one or more communication interfaces 13, 14 and/or one or more antenna interfaces (not shown) may be provided and furthermore, also one or more sensor interfaces (not shown) may be provided for acquiring data from sensors associated with the system.

Moving on, the controller 10 is configured to determine a global GOP sequence for the plurality of cameras 9. The global GOP sequence comprises one I-frame of each camera in the plurality of cameras. The global GOP sequence is a continuous or discrete time series, thus it can be construed as the smallest interval in time of the data output on the common transmission media 2 in which one can fit the I-frame from each camera 9.

Further, the controller is configured to determine a first distribution of I-frames in the global GOP sequence. This step may also be construed as detecting or observing a first distribution (i.e. unordered distribution) of I-frames within the determined global GOP sequence. Next, the control unit 10 is configured to form a second distribution (i.e. ordered distribution) of I-frames within the global GOP sequence by moving the I-frame of at least one camera 9 within the global GOP sequence so that the second distribution is different form the first distribution.

The controller 10 may be configured to perform any one of the method steps discussed in the foregoing in reference to FIG. 3. For example, the controller 10 may be configured to arrange the global GOP sequence into a plurality of sequential subsections together forming a group of subsections. Further, the controller 10 is configured to identify at least one high-density subsection and at least one low-density subsection in the group of subsections. In more detail, the controller 10 may for example review the number of I-frames within each subsection in the group of subsections and classify them based on the number of identified I-frames within each subsection. For example, each subsection having two or more I-frames can be classified as a high-density subsection, while each subsection having zero I-frames can be classified as a low-density subsection, and the remaining subsections can be classified as normal-density subsections. Based on this classification, the controller 10 can be configured to control the output of each camera 9 so that one or more I-frames from the high-density subsections is moved to one or more low-density subsections so that all subsections of the group of subsections can be re-classified as normal-density subsections. Thereby, the second distribution is formed, the second distribution having a more evenly spread bandwidth requirement within the global GOP sequence, as compared to the first distribution.

Preferably, the controller 10 is configured to ensure that no high-density subsections are formed in the second distribution.

In summary, the inventive method may be construed as, on a periodic basis, analysing a current distribution of I-frames within the global GOP, identifying a list {A} containing I-frames that are out of order, designating a new position for each I-frame in the list {A} within the global GOP sequence, and moving one or more I-frames from the list {A} to their new designated positions within the global GOP sequence. The event that invokes periodic reordering can be based on a periodic timer event, on the global GOP sequence, or an external command (e.g. the system controller noticing an increasing risk of congestion in the data traffic).

The present disclosure contemplates methods, devices and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor.

By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data that cause a general-purpose computer, special purpose computer, or special purpose processing machines to perform a certain function or group of functions. As already exemplified, some parts or all of the functions may be realized as a “cloud-based” solution.

Although the figures may show a specific order of method steps, the order of the steps may differ from what is depicted. In addition, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps. Additionally, even though the disclosure has been described with reference to specific exemplifying embodiments thereof, many different alterations, modifications and the like will become apparent for those skilled in the art.

It should be noted that the word “comprising” does not exclude the presence of other elements or steps than those listed and the words “a” or “an” preceding an element do not exclude the presence of a plurality of such elements. It should further be noted that any reference signs do not limit the scope of the claims, that the invention may be at least in part implemented by means of both hardware and software, and that several “means” or “units” may be represented by the same item of hardware.

The above mentioned and described embodiments are only given as examples and should not be limiting to the present invention. Other solutions, uses, objectives, and functions within the scope of the invention as claimed in the below described patent embodiments should be apparent for the person skilled in the art.

1-15. (canceled)

16. A method for managing data output from multiple cameras of a remote tower via a common transmission media to a central entity, wherein each camera is configured to periodically output an Intra frame, in a Group of Pictures, GOP, sequence, the method comprising:
determining a global GOP sequence for the multiple cameras, said global GOP sequence comprising the Intra frame of each camera of the multiple cameras;
determining a first distribution of Intra frames within the global GOP sequence; and
forming a second distribution of Intra frames within the global GOP sequence by moving the Intra frame of at least one of said multiple cameras within the global GOP sequence so that the second distribution is different from the first distribution.

17. The method according to claim 17, wherein:
the method further comprises identifying, in the first distribution of Intra frames, at least one time slot comprising at least two Intra frames, said time slot being of a limited length shorter than the global GOP sequence; and
the step of forming the second distribution comprises moving at least one Intra frame of the at least two Intra frames from said at least one time slot to a different time slot within the global GOP sequence.

18. The method according to claim 16, wherein:
the step of determining a first distribution of Intra frames within the global GOP sequence comprises:
dividing the global GOP sequence into a plurality of subsections;
identifying at least one high-density subsection, wherein the high-density subsection comprises a number of Intra frames above a first predefined threshold; and
identifying at least one low-density subsection, wherein the low-density subsection comprises a number of Intra frames below a second predefined threshold; and
the step of forming the second distribution within the global GOP sequence comprises moving an Intra frame from each identified high-density subsection to a corresponding low-density subsection.

19. The method according to claim 18, wherein the first predefined threshold and the second predefined threshold is equal to one.

20. The method according to claim 18, wherein:
the global GOP sequence comprises N Intra frames, wherein the step of dividing the global GOP sequence into a plurality of subsections comprises dividing the global GOP sequence into N subsections; and
the step of forming the second distribution within the global GOP sequence comprises moving an Intra frame from each identified high-density subsection to a corresponding low-density subsection such that each subsection out of the N subsections comprises one Intra frame.

21. The method according to claim 20, wherein the step of dividing the global GOP sequence into N subsections comprises:
forming a group of subsections comprising a series of the N subsections; and
aligning the group of subsections with said global GOP sequence based on a predefined metric.

22. The method according to claim 18, wherein the step of forming the second distribution within the global GOP sequence further comprises changing a status of each low-density subsection to a normal-density subsection when the Intra frame is moved thereto.

23. The method according to claim 18, wherein the subsections are of equal length.

24. A non-transitory computer-readable storage medium storing one or more programs configured to be executed by one or more processors of a remote tower system, the one or more programs comprising instructions for performing the method according to claim 16.

25. A remote tower system for air traffic control comprising:
a plurality of cameras arranged to transmit data output via a common transmission media to a central entity, each camera being configured to periodically output an Intra frame in a Group of Pictures, GOP, sequence; and
a controller arranged to monitor and control the data output of each camera onto the common transmission media,
wherein the controller is configured to:
determine a global GOP sequence for the plurality of cameras, the global GOP sequence comprising the Intra frame of each camera of the plurality of cameras;
determine a first distribution of Intra frames within the global GOP sequence; and
form a second distribution of Intra frames within the global GOP sequence by moving the Intra frame of at least one of the plurality of cameras within the global GOP sequence so that the second distribution is different from the first distribution.

26. The remote tower system according to claim 25, wherein the controller is further configured to:
identify, in the first distribution of Intra frames, at least one time slot comprising at least two Intra frames, said time slot being of a limited length shorter than the global GOP sequence; and
form the second distribution of Intra frames within the global GOP sequence by moving at least one Intra frame of the at least two Intra frames from said at least one time slot to a different time slot within the global GOP sequence.

27. The remote tower system according to claim 25, wherein the controller is further configured to:
arrange the global GOP sequence into a plurality of subsections;
identify at least one high-density subsection, wherein the high-density subsection comprises a number of Intra frames above a first predefined threshold;
identify at least one low-density subsection, wherein the low-density subsection comprises a number of Intra frames below a second predefined threshold; and
form the second distribution of Intra frames within the global GOP sequence by moving an Intra frame from each identified high-density subsection to a corresponding low-density subsection.

28. The remote tower system according to claim 27, wherein the global GOP sequence comprises N Intra frames, and wherein the controller is configured to:
arrange the global GOP sequence into N subsections; and
form the second distribution of Intra frames within the global GOP sequence by moving an Intra frame from each identified high-density subsection to a corresponding low-density subsection such that each subsection out of the N subsections comprises one Intra frame.

29. The remote tower system according to claim 28, wherein the controller is configured to arrange the global GOP sequence into N subsections by forming a group of subsections comprising the N subsections, and aligning the group of subsections with said global GOP sequence based on a predefined metric.

30. The remote tower system according to claim 27, wherein the controller is further configured to change a status of each low-density subsection to a normal-density subsection when the Intra frame is moved thereto.
